(19) United States
(12) Patent Application Publication
(10) Pub. No.: US 2009/0101721 A1
(43) Pub. Date: Apr. 23, 2009

(54) Emergency contact information and identification card

(76) Inventors: Anthony Dwane Hawthorne, Goodyear, AZ (US); Georgia Ann Hawthorne, Goodyear, AZ (US)

Correspondence Address: Anthony D. Hawthorne, 14465 W. Lexington Ave., Goodyear, AZ, 85395, US

(21) Appl. No.: 11/975,033

(22) Filed: Oct. 17, 2007

(51) Int. Cl. G06K 19/067

(52) U.S. Cl. 235/492

(57) ABSTRACT

A card utilized as an established method for contacting a decision-making individual or individuals (4) (5) relating to emergency situations wherein cardholder (2) is unable to do so; said card containing contact person or persons; embossed or imprinted telephone number or numbers (6) (7) (8) (9); stored medical information via magnetic strip or smart chip (10); embossed or imprinted cardholder name (2); whose purpose is to make it easy for a specified person to be notified in case of emergency; whereby said card can be readily used by citizens or emergency personnel.

### FEDERALLY SPONSORED RESEARCH

Not Applicable

### SEQUENCE LISTING OR PROGRAM

Not Applicable

### BACKGROUND

1. Field of Invention

This invention relates specifically to the ability to provide emergency phone contact, emergency medical information and emergency identification via a plastic credit card size card with a readable/writeable magnetic strip which allows civilians or emergency personnel to immediately retrieve the cardholder's choices of contact person(s) by phone, access to basic medical information, and to administer services.

2. Prior Art

At present, there is no sufficient, organized or universal method for a civilian/good Samaritan or emergency personnel to contact a relative of an individual who is unable to make contact on their own. At best, current identification on one's person might be a crude paper identification contact card offered in a new wallet, a state issued identification card, driver's license, or a personal phonebook or cell phone filled with unspecified numbers with no means of knowing specifically who to contact first in case of emergency. Mechanical devices with stored information can and do fail, i.e. a dead battery occurrence. Critical time is also lost when trying to learn vital medical information, how to contact specifically the next of kin for decision-making, in the event the cardholder is incapacitated, and to identify whom the person in duress might be. This could include non-drivers, or persons with no other form of identification, such as children or those incapable of obtaining a driver's license.

There are certain patents previously issued that cover several separate aspects of the collective whole of this invention. U.S. Pat. No. 5,955,952 issued to Bergman (1999) covers the method of locating a lost person or property by means of pre-registered subscription service, an information database and photo identification card, toll-free phone number and a unique personal identification number. This service is limited to lost persons or property, and does nothing to address the immediate needs of an incapacitated person requiring emergency services, providing emergency information, or knowledge to administer services, or recognizing the urgency of reaching a decision-making relative or friend if the cardholder is unable to do so. Contact efforts are made through a third party 1-800 phone number and a remotely maintained database, which hinders the immediacy of administering services or emergency contact. The magnetic strip incorporated with U.S. Pat. No. 5,955,952 is read by swiping the card through a magnetic strip reading apparatus-equipped telephone, to initiate a call to a central station operator, who likely, may not be trained in emergency procedures.

A patent issued to Yang, U.S. Pat. No. 6,224,109 (2001) is a credit card with driver's license for providing credit to an individual, with information regarding the individual and proof of registration to operate a motor vehicle on a single form of identification. It addresses the need for a combined identification, Department of Motor Vehicles (DMV) driver's license and credit card, but has no purpose-related aspects to this said invention. It does employ the use of a card, a magnetic strip, and a means of identifying its holder, but this is where the similarities of purpose and composition end. The depths of its usage are limited to operation of a vehicle and as a means of providing for both identification and credit validation, and make no claims to the purposes of emergency contact, identification or medical history.

Further attempts to find existing prior art led to review of U.S. Pat. No. 5,664,109 issued to Johnson (1997) whose function is the method for extracting pre-defined data items from medical services records generated by healthcare providers. By its limitations of scope, it does not employ any methods of personal identification, emergency contact, or knowledge of the holder's medical needs. Similarities end with the usage of the database function, wherein information could have come from and belong on record within healthcare providers, but do not extend to the purpose of allowing emergency services to be administered based on information from this data source.

Similarities further exist, but are not identical as discovered in U.S. Pat. No. 6,042,005 issued to Basile, Mark R. (2000) describing a personal identification and promotional system using personal and medical information, primarily directed toward the identification of children, employing photographs of the said child, parent/guardian, personal information, medical history, access phone numbers, and promotional corporate discounts via a local database. While this invention has duality of use, its limitations are to the identification of children only, it provides photographs and not readily available emergency contact numbers of more than one individual on the face of the card, and deviates from the focused urgency of our invention, by incorporating discounts from corporate sponsors. Basile's security measures could possibly delay needed access to emergency services necessary to aid in the immediate treatment of the child. Further discovery of Lodichand, Rudolph V., U.S. Pat. No. 6,262,666 (2001) describing a method of and apparatus for individuals to maintain a trail of their well being and whereabouts, does not emphasize urgency in case of medical emergency needs, but tracts a person's well being with a delayed follow-up to a non-responsive attempt to contact the individual. It also requires release of information to emergency contact only after attempts to reach the targeted person are unsuccessful.

All of the referenced inventions previously patented do not address the needs of rapid emergency contact and response of reaching parent, guardian, spouse, or loved one or any individual who can make critical decisions in case of a medical emergency, or in the event the cardholder is incapacitated, and further offers these disadvantages:
(a) Patents issued to date do not offer embossed names and emergency contact numbers visible on the face of the card.)
(b) Non-restrictive access to basic medical information via magnetic strip, capable of being read by current technology employed by EMS, Police, Fire and Hospital services.)
(c) Does not offer the distinct characteristics of a dedicated and recognized medical emergency apparatus. Most are partnered with dual facets such as driver's license components, credit cards and corporate credits.)
(d) Offers limitations to the card holder's location, and requires going through a central database to retrieve information or to activate the card.)
(e) Restrictive to the age group it supports either directed to adults only or children only, with specific information stored for the purpose of revealing preexisting medical conditions only.
(f) Used as a device to store information and track an individual's “well-being” and attempts contact only after failed attempts to directly reach a targeted individual.)
(g) Vehicle used as a data storage source; not as a means of administering services or defining a cardholder's basic medical information.

### SUMMARY

A universally recognized card for the purpose of identification and identifying designated contact individual(s) in case of emergency as established by the cardholder in case of cardholder's inability to do so.

### DRAWINGS—FIGURES

FIG. 1 shows front side of the plastic card in accordance with one embodiment.

FIG. 2 shows back side of the plastic card in accordance with one embodiment.

### DRAWINGS—REFERENCE NUMERALS

1 Embedded Card Name
2 Embossed Cardholder's Name
3 Embedded In Case of Emergency Please Notify:
4 First Designated Contact Individual Name
5 Second Designated Contact Individual Name
6 First Contact Phone Number for First Designated Individual
7 Second Contact Phone Number for First Designated Individual
8 First Contact Phone Number for Second Designated Individual
9 Second Contact Phone Number for Second Designated Individual
10 Readable/Writeable Magnetic Strip with coded information on height/weight, blood type, medical conditions (if any), medication (if any) allergies (if any) name, address, home phone number, social security number, healthcare provider, healthcare provider phone number, and all information from the front of the card.
11 Visible Brief Medical Information—Allergies, Prescription Medications and Medical Conditions and Blood Type.

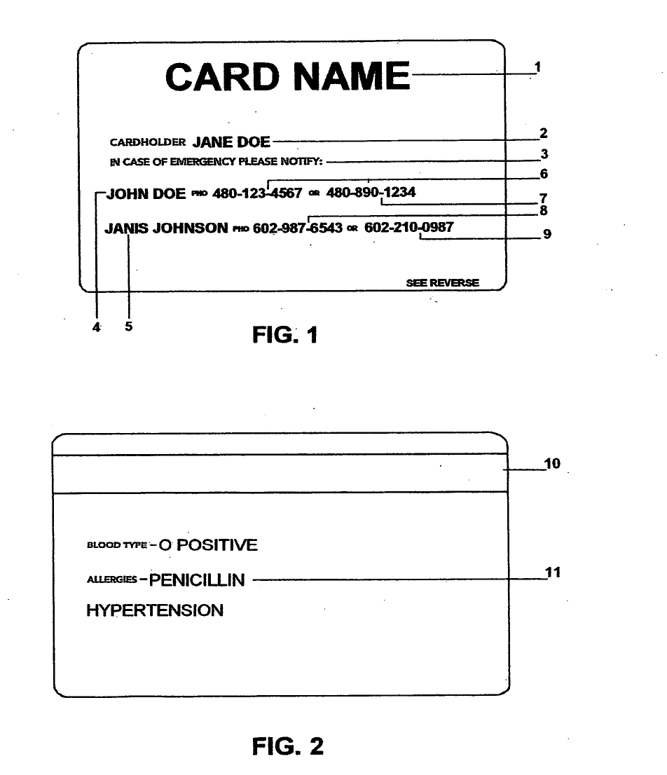

### DETAILED DESCRIPTION—FIGS. 1 AND FIGS. 2—PREFERRED EMBODIMENT

One embodiment of the card is illustrated in FIG. 1 (front view) and FIG. 2 (back view). Standard plastic credit card size card 3⅜″ length×2⅛″ height, from 0.25 mm to 0.76 mm thickness, and typically has two or three layers of PVC-related polymers. Usually, one layer is screen printed, with a clear PVC layer laminated on top. The printed surface, sandwiched between two plastic sheets, acts as an adhesive so the effects of printing on the card must be assessed. Other features, such as special finishes, magnetic strips, signature panels, holograms and smart chips will also affect the design of the card. Inks used on the cards are solvent based, or UV-cure inks are on the rise.

A plastic card allows for embedding (1 and 3) and embossing (2, 4, 5, 6, 7, 8, 9) selected information FIG. 1—The front side of the card has an embedded Card Name 1(=Company Name) which is prepared during card manufacturing process. Also, 3 (In Case of Emergency Please Notify:) is embedded during manufacturing. In the preferred embodiment the card is plastic; however, the card can consist of thin metal, coated cardboard or paper, although the latter two would be less durable.

Embossed areas (2, 4, 5, 6, 7, 8, 9,) are created by a computer-aided heat-melt process, this creates raised lettering. Data is pre-selected via a database and is exclusive to each card per the specific information provided by each cardholder. 2 Embossed cardholder's name identifies the specific cardholder. 4 identifies first designated contact individual's name, 5 identifies second designated contact individual's name, 6 is the first contact phone number for the first designated individual, 7 is the second contact phone number for the first designated individual, 8 is the first contact phone number for the second designated individual, 9 is the second contact phone number for the second designated individual. 10, on the backside of the credit card size card, at the top of the card is a readable/writeable magnetic strip which can be encoded with basic information specific to the cardholder. Height, weight, blood type, medical conditions (if any), medications currently taking, (if any), allergies, (if any), name, address, home phone number and all information from the front of the card. 11, is brief medical information that is visible on the backside of the card. Data could include blood type, medical conditions, medication, allergies, etc.

### Advantages

Although these referenced patents offer advantages relative to their specific services, our product offers several advantages not found in these offerings, which are:
(a) To provide emergency contact information on the face of the card for the purpose of notifying a decision maker on behalf of the incapacitated card holder.
(b) To provide basic information accessible via a magnetic strip which can currently be read by an available magnetic strip reader/writers used by EMS, Police and Fire services.
(c) To provide specific card holder information, whose primary purposes are to provide identification, provide emergency contact sources, and to store basic medical information.
(d) To provide immediate and direct services to the cardholder without delay, with no limitations on the person's location or need to activate the card for usage.
(e) To provide unrestricted access to all age groups for purposes beyond reviewing pre-existing medical information.
(f) To provide needed medical information as a result of an emergency, and not as a tracking device. Provides information to assist the incapacitated card holder and then notifies those who would be able to make decisions on behalf of the individual.
(g) To provide real-time medical information in case of an emergency, and allow access to basic medical data.

Further objects and advantages are: upon discovery of this card in a person's possession, it is universally recognizable as a medical assistance card by its color, logo and information on its face as a means of identification of the card holder, and names of contact person(s) and up to four contact phone numbers. It would follow the dimensions and size of a credit card, and would be easily manufactured and cost effective. Information can be readily updated, and due to the low cost to manufacture the card can be completely replaced. The embossed information on the face of the card ensures this vital information is tamper-proof. By providing specific names and numbers, this device eliminates the delayed reaction time usually associated with notifying the next of kin or a person who can make decisions in case of an emergency. The reverse side of the card contains a read/write magnetic strip encoded with basic medical information specific to each cardholder. Also visible are the individual's blood type, medical condition, allergies and current medications. In addition, the strip duplicates the information on the front side of the card for printable use, which includes the cardholder's name, address, contact person(s) and four contact phone numbers.

### CONCLUSION, RAMIFICATIONS AND SCOPE

This contact card simplifies the effort to provide varying degrees of service to an incapacitated individual in the event of an emergency situation, thus allowing emergency personnel or a civilian to render immediate assistance. The contact card identifies the cardholder, provides information on present medications and medical conditions and identifies individuals to contact who can provide further information for assistance and decision-making. Furthermore, the emergency contact card has additional advantages in that:
It is designed to be universally recognized by its name, color, size and configuration;
It combines information in one source eliminating the need to seek data from several information sources (i.e. driver's license/id, insurance card, cell phone, address book etc.);
It targets the designated decision makers as determined by the card holder so that critical time is not lost;
It provides a universal platform as an identification card for every man, woman and child with a magnetic strip and can be inexpensively produced and reproduced;
It can readily be replaced in case of loss, damage, or cardholder life event changes.

The characteristics described above identifies specific aspects of the contact card, however these do not limit the proposed incarnation. There are other incarnations or considerations such as inclusion of smart chip technology, metal sandwiched between plastic, and linked services to company insurance plans.

Thus the scope or the embodiment should be determined by the appended claims and their legal equivalents, rather than by the examples given.

I claim:

1. The universal method for establishing swift contact or notification in an emergency situation comprising: a standard card with a minimum of one embossed or imprinted predetermined contact individual; and a minimum of one embossed or imprinted predetermined contact telephone number on face of the card; for the purpose of direct contact with said individual; said card contains embossed or imprinted cardholder name; reverse side contains a magnetic strip or smart chip, which is coded with specific medical information predetermined by said cardholder; information contained herein can be utilized by citizens after first contacting emergency personnel for assistance; said card is typically carried in one's wallet or purse, and is readily identifiable by its bold logo, colors and shape.

2. The method of claim 1 which comprises the use of a telecommunication devices such as wireless cellular, satellite phone, residential line, or public telephone device.

3. The method of claim 1 which comprises the use of a magnetic strip, which can also employ smart chip technology.
